(19) United States
(12) Patent Application Publication
(10) Pub. No.: US 2011/0033819 A1
(43) Pub. Date: Feb. 10, 2011

(54) METHOD FOR PRODUCING A TREATMENT JIG

(75) Inventors: Dirk Freyer, Bonn (DE); Gerhard Zuendorf, Bonn (DE)

Correspondence Address: MILLEN, WHITE, ZELANO & BRANIGAN, P.C., 2200 CLARENDON BLVD., SUITE 1400, ARLINGTON, VA, 22201, US

(73) Assignee: SICAT GMBH & CO.KG, Bonn (DE)

(21) Appl. No.: 12/740,622

(22) PCT Filed: Sep. 18, 2008
(86) PCT No.: PCT/EP2008/062439

§ 371 Date: Apr. 29, 2010

(30) Foreign Application Priority Data
Oct. 31, 2007 (DE) 102007052389.2

(51) Int. Cl. A61C 3/00

(52) U.S. Cl. 433/72

(57) ABSTRACT

Process for manufacturing a treatment template, in particular a drilling template 7, which is used for pinpoint guidance of an instrument in the oral cavity of a patient, whereby the treatment template is secured in a detachable manner during an operative intervention in the jaw area of the patient in defined position,
whereby in the jaw area, a holder is anchored especially by implantation for detachable fastening of the treatment template 7,
whereby the holder has marker structures 1a that put up a three-dimensional coordinate system and that can be shown by an imaging process together with the anatomy of the patient,
whereby a set of three-dimensional image data of the jaw area 2 that is equipped with a holder is recorded,
in that based on the image data, the planning of the implants and the planning of the treatment template 7 that is to be secured in a defined manner to the holder is done, whereby the plans relate to the coordinate system that is put up by the marker structures 1a.

This invention relates to a process for manufacturing a treatment template, in particular a drilling template, which an attending physician uses for pinpoint guidance of his instrument, in particular his drill, in the oral cavity of a patient. Such a treatment template is secured in a detachable manner during the operative intervention in the jaw area of the patient in defined position. The invention also relates to a system for supporting an implantation by means of a treatment template that is produced according to the process.

From the prior art, different types of treatment templates are known that are used as drilling templates in jaw surgery. These drilling templates offer the physician's drill a defined guide relative to the drilling position, the drilling angle and the drilling depth. They are produced within the framework of a plan and with coordination of various reference systems. In this case, drilling templates are known that are applied to the remaining teeth by means of an impression compound. The correct positioning and securing of the drilling template is comparatively unproblematic in such a jaw with some teeth since the template can be connected to the remaining teeth in a reproducible manner.

Handling an at least almost toothless jaw by means of a drilling template is problematic, however, since such a template, if it is applied only by the mucous membrane, cannot be positioned precisely enough and attached securely enough because of the resiliency of the mucous membrane. In such cases, other drilling templates, which—as described as in EP 0 756 735 B1—are anchored directly in the bone, are used. This procedure is not especially comfortable for the patient, however, since his mucous membrane has to be folded back over a large surface for the mounting of the drilling template.

Also, US 2004/0259051 A1 describes a process for the production of a drilling template that is suitable for a toothless jaw, after whose production special anchor elements that are suitable for a securing process are introduced into the jaw. After the described procedure, the drilling template is secure, but is not automatically secured in the correct position. In this case, the improper seating can result in holes that deviate from the original plan. Also, U.S. Pat. No. 6,793,491 describes a similar system of temporary implants for holding a drilling template, in which the correct positioning is difficult.

In “Harel, Journal of Prosthetic Dentistry, 2/2002,” the use of temporary implants in the preliminary area of imaging is described, whereby a scanning template that is provided with markers does not rest on the gum but rather is anchored in temporary implants. In a later step, a drilling template that can be positioned exactly on the temporary implants and can be secured is made from the scanning template. This method is accompanied by a high logistical expense, since first the scanning template with the marker elements has to be made by means of a plaster model, and the plaster model and/or the scanning template as well as the image and planning data have to be brought to the production site of the drilling template.

Thus, the production of a drilling template often takes place by means of a plaster model of the patient's jaw, whereby the plaster model represents a potential source of errors in the manufacturing of a drilling template in as much as it cannot always be manufactured with adequate quality. The result is that the drilling template clearly does not match the patient's jaw.

The object of the invention is now to propose a process for manufacturing a treatment template, in particular a drilling template, for the jaw with too few teeth, which can be produced economically with simple means and that results in a treatment template that is exactly and securely positioned relative to the plan. Moreover, the object is to propose a system that is simple to handle and suitable for practice for supporting an implantation in the jaw area.

These objects are achieved by the process according to claim 1 and the system according to claim 10. Advantageous embodiments of the invention are mentioned in the respective subclaims.

The essential idea of the invention is summarized in that in the jaw area of the patient, first a holder of the later detachable fastening of a treatment template is anchored in particular in the upper jaw or in the lower jaw of the patient, which is removed again after the end of the treatment and therefore forms a “temporary” implant. This holder has markings in the form of marker structures that put up a coordinate system and are visible within the set of the recorded 3D image data. Now, the image data from the patients who are equipped with this holder are recorded by means of a tomographic process, in particular by means of a computer tomograph (CT) or a digital volume tomograph (DVT). Then, based on these 3D image data, on the one hand, the implant can be planned, and on the other hand, the treatment template that is necessary for the installation of this implant can be planned. A treatment template that is produced in such a way is equipped with means, such as correspondingly oriented drill sleeves, which offer the physician's drill a defined guide relative to the drilling position, the drilling angle and the drilling depth. The guiding of successive drills with different diameters can be achieved with the use of several, corresponding inside sleeves, which are put in a common outside sleeve.

Since the marker structures put up a coordinate system for the planning data, the latter can also be used for computer-controlled manufacturing tools, such as CNC milling machines, with which the treatment template is manufactured from, for example, plastic. It is especially advantageous, however, to produce the treatment template with a rapid prototyping process, whereby this process is also oriented on the planning data. The manufactured treatment template can then be installed snugly and securely in the oral cavity of the patient by means of the previously implanted holder for the purpose of introducing the drill that is provided for the implant.

This invention also employs one or more temporary implants along with the holder, whereby, however, the logistical expense is considerably reduced relative to the known process and possible sources of error are eliminated. In particular, in the process according to the invention, the use of a plaster model, whose quality for the success of treatment is important according to the most common process, can be eliminated.

According to the invention, the holder is thus anchored for detachable fastening of the treatment template in the jaw area of the patient, whereby this anchoring takes place in particular in turn by implantation. In turn, the holder has the marker structures that put up a three-dimensional coordinate system in the image data that is to be recorded and therefore can be shown by the imaging process together with the anatomy of the patient. Since the imaging process in most cases employs x-ray radiation, it is advantageous to provide marker structures that can be clearly seen in 3D volume, but do not cause major artifacts. Therefore, various metallic, ceramic, glass-like or plastic-based materials are attractive, which are advantageously associated with the material of the holder.

From the jaw that is equipped with the holder, a set of three-dimensional image data is recorded, for example, by means of a DVT, based on which the planning of the implants and the planning of the treatment template that is to be attached in a defined manner to the holder is done. All plans and manufacturing processes can be oriented to the coordinate system that is put up by the marker structures.

An essential aspect thus lies in the holder that—in a preferred embodiment—can be formed by a type of base, which is implanted as such in the patient's upper or lower jaw. This base can have a “standardized” mechanical interface for fastening the treatment template. This interface is to be designed so that an exact and secure attachment of the treatment template is possible. Snug couplings such as those of the Lego system, which are secured, for example, with locking elements, are especially attractive for this purpose. When such standardized, premanufactured interfaces are used, no additional planning and manufacturing work needs to be put into the type of coupling.

In another advantageous embodiment, the holder of several, in particular three, holding means that are to be anchored separately is formed, and said holding means are respectively placed individually in each case as temporary implants in the patient's jaw. Each of these holding means is provided with its own marker structure that is invisible in the image data and with a fastening means. As such holding means, for example, small pins, in particular screws, which are implanted in a suitable location in the jaw and whose heads form a quasi marker structure and fastening means, can be used. In this case, it is especially advantageous to anchor the holding means spaced as far apart as possible and in a triangle in the jaw area. In such a way, attached holding means distributed over a sizeable area can have an especially secure hold, and a defined positioning of the treatment template in the jaw can be achieved. Since the positioning is individual, however, the opposing bearings to the treatment template, which work together with the fastening means, have to be manufactured individually. This individual manufacturing is no problem, however, with the above-mentioned process, for example the rapid prototyping. Another advantage of the method is that the temporary implants can hold a temporary prosthesis until the final prosthesis has been completed.

To make possible a good and defined fastening of the treatment template, it is advantageous to design the fastening means as a ball head or cylinder that forms a defined seating for a socket that is correspondingly introduced into the treatment template. The treatment template is then mounted by the physician on the fastening means and secured in the mounted state. Securing can be done by means of, for example, small screws that engage behind the ball head and the cylinder respectively. So that it can also be ensured that the treatment template is mounted exactly, it is advantageous to provide controlling means that indicate to the physician the secure seating.

Below, the invention is explained in more detail based on FIGS. 1 to 5. Here:

FIG. 1 shows an upper jaw with some teeth,

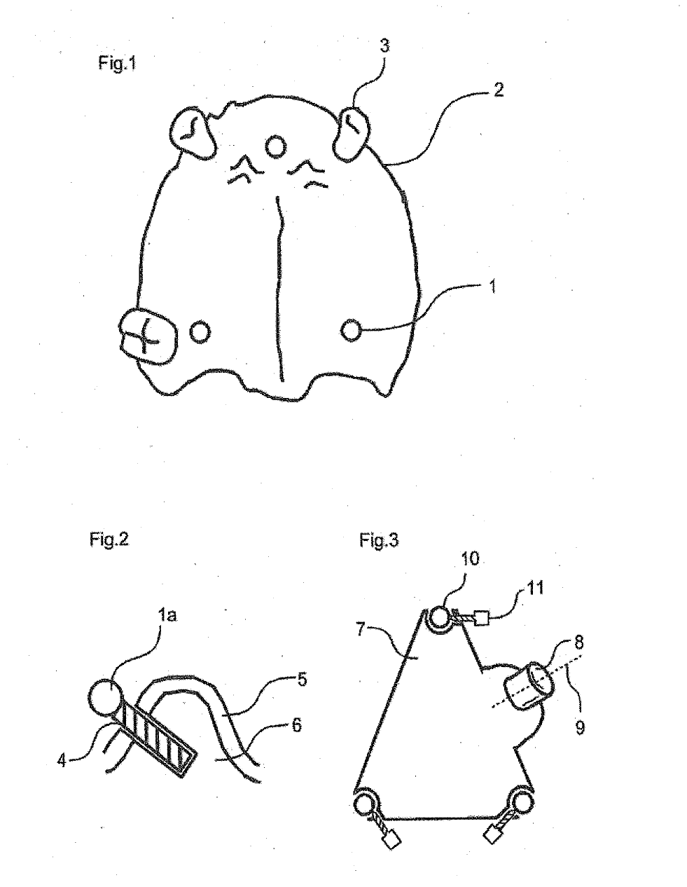

FIG. 2 shows a section through the upper jaw,

FIG. 3 shows a secured drilling template,

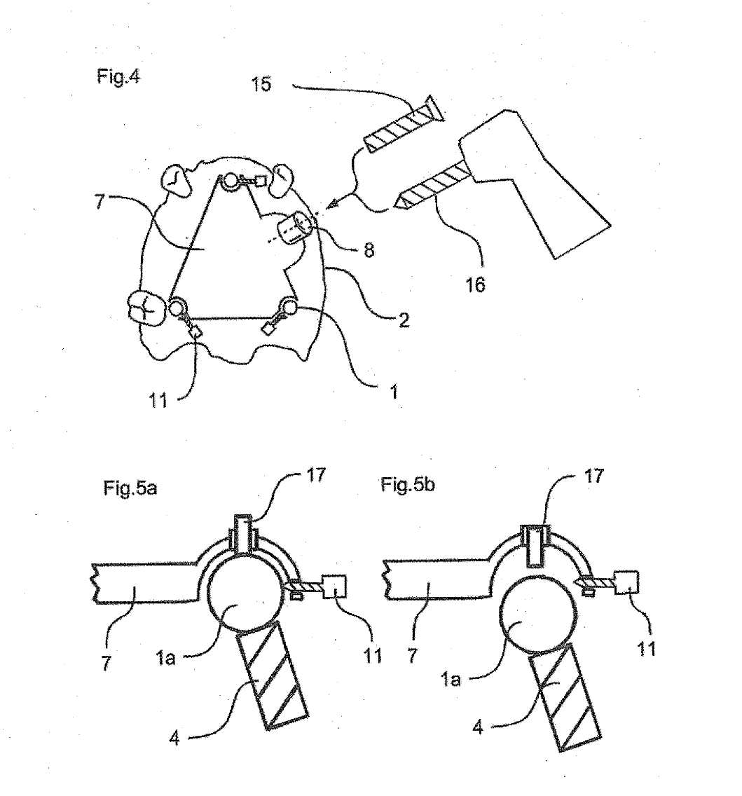

FIG. 4 shows a drilling template that is secured in the upper jaw, and

FIG. 5 shows a stopping means.

FIG. 1 shows a patient's upper jaw 2, which has three teeth 3 in the section with remaining teeth. In upper jaw 2, a holder with three temporarily implanted holding means 1 that are arranged in a triangle is introduced. The holding means 1 have ball heads that are used, on the one hand, as marker structures, and, on the other hand, as fastening means. FIG. 2 shows a cross-section through the upper jaw and a temporarily implanted holding means 1, which in this example has a ball-shaped adapter in the form of a ball head la. The holding means 1 is screwed with threading 4 to the jaw ridge 6 through the mucous membrane 5.

FIG. 3 shows a drilling template 7 that is mounted and secured on the three holding means 10. To fasten the drilling template 7 to the holding means 10, screws 11 are used for stopping. In the drilling template 7, a drill sleeve 8 is introduced that has a drilling shaft 9 that is designed relative to the holding means 10. The corresponding application of the drilling template 7 that is secured in the patient's jaw 2 is shown in FIG. 4. The drilling template 7 is secured in the temporary holding means 1 by the stop 11. By the drill sleeve 8, a guided implant drill can be introduced with the drill 16, and the implant 15 can be applied in a guided way.

FIG. 5a shows the drilling template 7 on the ball head la in the locking position. As a control means, a stop indicator 17 is provided, which is pressed out into the locking position by the ball head 1a from its rest position. It thus signals to the physician that the locking position has been reached. As long as the locking position is not yet occupied, the stop indicator 17 remains in its rest position (FIG. 5b) and is held there by a return mechanism, for example by a spiral spring.

Below, the individual steps are indicated once more for the production of the implant-carried drilling template according to the invention:

First, temporary implants are introduced as holding means in the patient's jaw, whereby the latter should be spaced as far as possible from one another. Then, a 3D scan of the jaw is performed, and the seating of the holding means in the 3D volume data is determined. Below, virtual planning of the implants for long-term prosthetic care is done by means of a planning program. Subsequently, the forwarding of the planning data as well as the positional data of the temporary implants to a computer-controlled machine, for example a CNC mill or a device for rapid prototyping, takes place. The thus produced drilling template has locking openings that exactly match the counterparts of the temporary holding means. The positioning and the securing of the drilling template to the temporary holding mean in the patient's jaw and particularly the implementation of the operation then take place.

1. Process for manufacturing a treatment template, in particular a drilling template (7), which is used for pinpoint guidance of an instrument in the oral cavity of a patient, whereby the treatment template is secured in a detachable manner during an operative intervention in the jaw area of the patient in defined position,
characterized in that in the jaw area, a holder is anchored especially by implantation for detachable fastening of the treatment template (7), whereby the holder has marker structures (1a) that put up a three-dimensional coordinate system and that can be shown by an imaging process together with the anatomy of the patient,
in that a set of three-dimensional image data of the jaw area (2) that is equipped with a holder is recorded,
in that based on the image data, the planning of the implants and the planning of the treatment template (7) that is to be secured in a defined manner to the holder is done, whereby the plans relate to the coordinate system that is put up by the marker structures (1a).

2. Process according to claim 1, wherein the treatment template (7) is manufactured by means of a computer-controlled device, in particular made of plastic, whereby the manufacturing takes place in the coordinate system that is put up by the marker structures (1a).

3. Process according to claim 2, wherein the treatment template (7) is produced by means of a rapid prototyping process.

4. Process according to claim 1, wherein the holder is anchored in the upper jaw (2) or in the lower jaw of the patient.

5. Process according to claim 1, wherein the holder has several, in particular three, holding means that are to be anchored separately, whereby in each case, a holding means is provided with respectively one marker structure (1a) that can be seen in the image data and a fastening means (1a).

6. Process according to claim 5, wherein as holding means, pins, in particular screws, are anchored, whose head (1a) forms a marker structure and at the same time a fastening means for the treatment template (7).

7. Process according to claim 6, wherein the fastening means forms a ball head that forms a defined seating for a socket that is correspondingly configured in the treatment template (7).

8. Process according to claim 6, wherein the holding means are spaced as far apart as possible and are anchored arranged in a triangle in the jaw area (2).

9. Process according to claim 1, wherein the exact seating of the treatment template (7) on the fastening means is ensured based on control means (17) provided on the treatment template (7).

10. System for supporting an implantation by means of a treatment template (7) that is produced according to the process according to claim 1, characterized by a holder that is to be implanted temporarily in the jaw area (2) of a patient with marker structures (1a) that put up a three-dimensional coordinate system and the treatment template (7), in particular drilling template, to be attached in a detachable manner in the holder.

11. System according to claim 10, wherein the holder is designed as a base that has a mechanical interface for defined fastening of the treatment template (7).

12. System according to claim 10, wherein the treatment template (7) has a drill sleeve (8) with a drilling axis (9) that is designed relative to the holding means.
